(19) United States
(12) Patent Application Publication
(10) Pub. No.: US 2009/0117220 A1
(43) Pub. Date: May 7, 2009

(54) Auxiliary supporting structure for presses, and plastics molding press equipped with such a structure

(75) Inventors: Maurizio Bazzo, Oderzo (IT); Dario Girelli, Brescia (IT); Lorenzo Rubert, Vittorio Veneto (IT)

Correspondence Address: DAVIDSON BERQUIST JACKSON & GOWDEY LLP, 4300 WILSON BLVD., 7TH FLOOR, ARLINGTON, VA, 22203, US

(73) Assignee: INGLASS S.p.A., SAN POLO DI PIAVE (IT)

(21) Appl. No.: 11/979,477

(22) Filed: Nov. 5, 2007

(30) Foreign Application Priority Data
Nov. 3, 2007 (IT) TV2006A 000198

(51) Int. Cl. B29C 45/76

(52) U.S. Cl. 425/149

(57) ABSTRACT

An auxiliary supporting structure for presses, having an auxiliary mold platen having a front surface designed to firmly, but removably, support a half-mold; a number of hydraulic supporting cylinders, which project from the rear of the auxiliary mold platen, in a direction parallel to a reference axis perpendicular to the plane of the auxiliary mold platen; mounting means for firmly, but removably, fixing the hydraulic cylinders to the front surface of a movable mold platen of the press; a hydraulic distributor for regulating pressurized-oil flow to and from each hydraulic cylinder independently of the others; and an electronic central control unit for controlling the hydraulic distributor as a function of signals from a number of external sensors, to enable the hydraulic cylinders to instantaneously compensate any asymmetric distribution of the mechanical forces exerted on the half-mold as the plastic material is injected.

The present invention relates to an auxiliary supporting structure for presses, and to a plastics molding press equipped with such a structure.

More specifically, the present invention relates to an auxiliary supporting structure for plastics injection-compression molding presses, to which the following description refers purely by way of example.

### BACKGROUND OF THE INVENTION

As is known, in injection-compression molding, the molten plastic material is injected into the mold cavity—negatively reproducing the shape of the part for molding—when the two half-molds—eventually defining the mold cavity when closed—are still open and moving towards each other.

The main advantage of injecting the plastic material beforehand into the mold cavity and compacting it as the half-molds close is that it allows the plastic material to fill even the smallest recesses of even highly elaborate mold cavities before it begins to set.

Presses employing this method must therefore be equipped with two mold platens positioned parallel and facing, and each designed to support a respective half-mold; and an electronically controlled platen actuating device designed to push the two platens against each other, while real-time controlling the approach travel of the two platens, so as to accurately and instantaneously adjust the position of the half-molds with respect to each other at the final closing stage, and so evenly compact the plastic material with considerable compression pressure.

In addition, when working with exceptionally high injection pressures, and when the plastic material injection points are arranged asymmetrically inside the mold cavity, the half-molds are subjected at the injection stage to severe, highly unbalanced, pulsating mechanical forces that tend to rotate the half-molds with respect to each other, and which, if not counteracted by the press, may affect alignment of the two platens, thus resulting in damage to the half-molds and/or to the supporting columns of the press guiding the movement of one of the two mold platens.

To safeguard against this, more recent plastics injection-compression molding presses have a first mold platen fixed rigidly to the supporting frame of the machine; and a second mold platen connected movably to the supporting frame of the press simply by means of a number of independent hydraulic cylinders arranged side by side at the back of the second mold platen to push it against the first mold platen, while counteracting any tendency of the second platen to rotate with respect to its barycentre.

More specifically, in multicylinder presses, the second mold platen is not supported or guided by the supporting columns surrounding, and extending parallel to the travelling direction of, the two mold platens; and the hydraulic cylinders are parallel to the supporting columns, have one axial end resting on the back of the second mold platen, have the other axial end resting on the supporting frame of the press, are each located adjacent to a respective supporting column of the press, and are all controlled independently by electronically controlled, proportional hydraulic distributors to move the second mold platen to and from the first mold platen, while also controlling the orientation of the second platen as it approaches the first platen.

Unfortunately, multicylinder presses of the above type are extremely expensive to produce, thus making injection-compression molding economically unfeasible, despite the better quality and surface finish of the end products; whereas cheaper toggle presses or similar, on account of the much simpler platen actuating mechanism, fail to provide for combined control of the position, pressure, and orientation (parallelism) of the two mold platens, and are therefore incompatible with the injection-compression molding method as described above.

### SUMMARY OF THE INVENTION

It is an object of the present invention to provide a plastics injection-compression molding press that is cheaper and easier to produce than multicylinder presses.

According to the present invention, there is provided an auxiliary supporting structure for presses, as claimed in the attached Claims.

According to the present invention, there is also provided a plastics injection-compression molding press as claimed in the attached Claims.

### BRIEF DESCRIPTION OF THE DRAWINGS

A non-limiting embodiment of the present invention will be described by way of example with reference to the accompanying drawings, in which:

FIG. 1 shows a side view of a plastics injection-compression molding press in accordance with the teachings of the present invention;

FIG. 2 shows a schematic detail of the FIG. 1 press in operation.

### DETAILED DESCRIPTION OF THE INVENTION

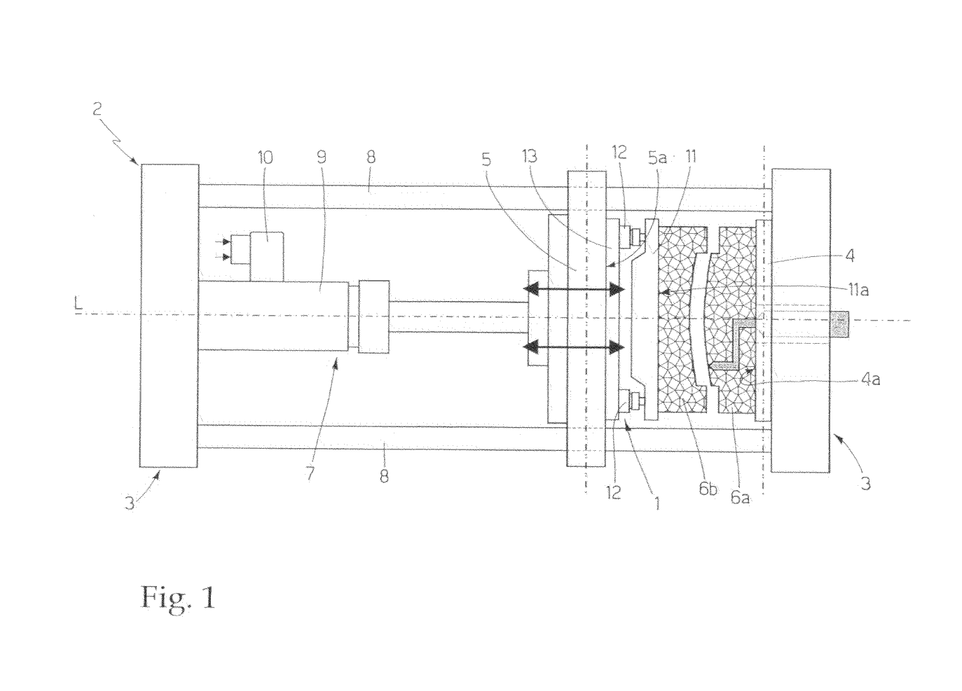

Number 1 in FIG. 1 indicates as a whole an auxiliary supporting structure for presses, designed to actively compensate unbalanced loads, and specifically for assembly to a preferably, though not necessarily, horizontal-axis plastics molding press 2.

Press 2 substantially comprises an on-floor supporting frame 3; and two mold platens 4, 5, which are fitted to supporting frame 3 of the machine, are aligned along the longitudinal axis L of the machine, perfectly parallel and facing each other, so as that the lying planes of said mold platens are perpendicular to longitudinal axis L; are designed to move one against the other in a direction parallel to longitudinal axis L of the press; and are each designed so that its front surface 4a, 5a—i.e. the surface directly facing the other mold platen 4, 5—can support, firmly but in easily removable manner, one of the two half-molds 6a, 6b, which, when closed, form, at the join, a mold cavity 6 negatively reproducing the shape of the part for molding.

Press 2 also comprises a platen actuating device 7 fixed to supporting frame 3 of the press, and which, on command, is able to move the two mold platens 4, 5 cyclically against each other, in a direction parallel to longitudinal axis L, to close the half-molds 6a, 6b secured to front surfaces 4a, 5a of mold platens 4, 5.

More specifically, mold platen 4 is fixed rigidly to supporting frame 3 of the press, and platen actuating device 7 pushes mold platen 5 against mold platen 4 to close the half-molds 6a, 6b secured to front surfaces 4a, 5a of mold platens 4, 5.

With reference to FIG. 1, in the example shown, mold platen 5 is mounted in sliding manner on a number of straight supporting columns 8, which form part of supporting frame 3 of the press, extend side by side in a direction parallel to longitudinal axis L, and are arranged along the whole perimeter of mold platen 4 to define a rigid cage inside which mold platen 5 is mounted movably.

More specifically, in the example shown, both mold platens 4, 5 are substantially rectangular, and supporting columns 8 of supporting frame 3 are four in number and located at the corners of a rectangle surrounding mold platen 4.

Platen actuating device 7 is located behind mold platen 5, i.e. on the opposite side to mold platen 4, and, in the example shown, comprises a double-acting hydraulic thrust cylinder 9, which extends coaxially with, or at any rate parallel to, longitudinal axis L of the press, and has one axial end integral with supporting frame 3 of the press, and the other axial end integral with the rear of mold platen 5; and a hydraulic distributor 10 which, in known manner, regulates pressurized-oil flow to and from the chambers of hydraulic cylinder 9 to move mold platen 5, on command, along columns 8 to and from mold platen 4, and so close the half-molds 6a, 6b secured to front surfaces 4a, 5a of mold platens 4, 5.

In a different embodiment, platen actuating device 7 may obviously also comprise a toggle mechanism, which is commonly known and therefore not further described in detail.

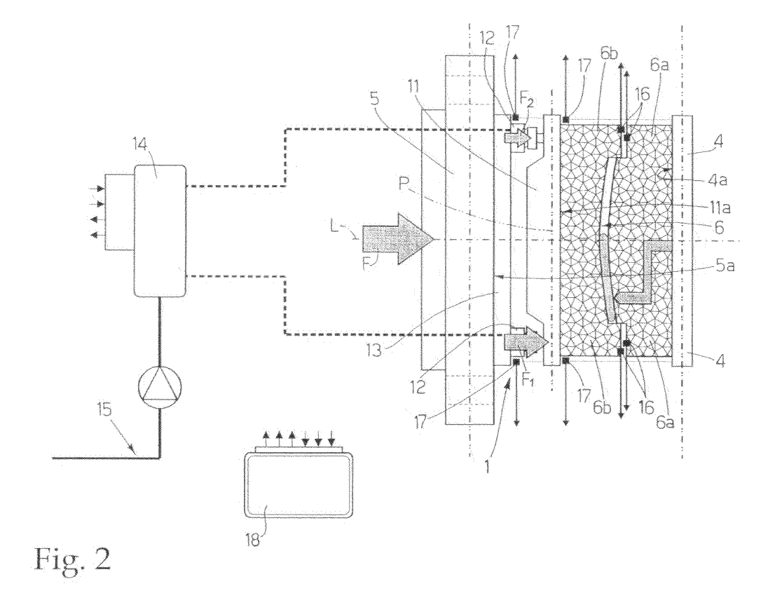

With reference to FIGS. 1 and 2, auxiliary supporting structure 1 is secured firmly, but removably, to front surface 5a of mold platen 5, between half-mold 6b and mold platen 5 itself, and is designed to keep half-mold 6b perfectly aligned with and parallel to half-mold 6a secured to the opposite mold platen 4, by instantaneously balancing the asymmetrical mechanical forces that tend to rotate half-mold 6b with respect to half-mold 6a as the plastic material is fed into mold cavity 6 before half-molds 6a, 6b are closed (FIG. 2).

In other words, auxiliary supporting structure 1 is secured firmly, but removably, to front surface 5a of mold platen 5, and is designed in turn to support half-mold 6b firmly but in easily removable manner.

Auxiliary supporting structure 1 comprises an auxiliary mold platen 11 located to the front of mold platen 5, i.e. between mold platens 5 and 4, at a predetermined distance from front surface 5a of main mold platen 5, and designed to support half-mold 6b firmly but in easily removable manner; a number of single- or double-acting hydraulic supporting cylinders 12, which are interposed between mold platens 5 and 11, are parallel to longitudinal axis L of the press, and each have one axial end resting on mold platen 5, and the other axial end resting on mold platen 11; and a mounting platen or other mounting member 13, by which to fix hydraulic supporting cylinders 12 rigidly and firmly, but removably, to front surface 5a of mold platen 5.

More specifically, the front surface 11a of mold platen 11 facing mold platen 4 is designed to support half-mold 6b firmly but in easily removable manner; and hydraulic cylinders 12 project from the rear of mold platen 11 towards mold platen 5, are locally perpendicular to the plane P of mold platen 11, in turn perpendicular to longitudinal axis L of the press, and are arranged along the whole perimeter of mold platen 11.

In other words, auxiliary supporting structure 1 is fixed to front surface 5a of mold platen 5 by means of mounting platen 13, so that hydraulic cylinders 12 are all parallel to longitudinal axis L of the press, and plane P of mold platen 11 is perpendicular to longitudinal axis L of the press.

In the example shown, mold platen 11 and mounting platen 13 are substantially rectangular, and hydraulic cylinders 12 of auxiliary supporting structure 1 are located at the four corners of mold platen 11 and mounting platen 13.

With reference to FIG. 2, auxiliary supporting structure 1 also comprises an electronically controlled, proportional hydraulic distributor 14 connected to the hydraulic circuit 15 of the press to regulate pressurized-oil flow to and from each hydraulic cylinder 12 independently of the others; a number of external sensors for instantaneously determining the position of half-molds 6a, 6b with respect to each other, and/or distribution of the mechanical forces acting on half-molds 6a, 6b, and/or distribution of the pressures acting on the mating surfaces of half-molds 6a, 6b, and/or the oil pressure inside each hydraulic supporting cylinder 12; and an electronic central control unit 18 for controlling hydraulic distributor 14 as a function of the signals from the sensors, to enable hydraulic cylinders 12 to instantaneously compensate any asymmetric distribution of the pulsating mechanical forces arising between half-molds 6a and 6b as the plastic material is injected, and so counteract the twisting torque that tends to rotate half-mold 6b with respect to half-mold 6a, so that half-molds 6a, 6b are maintained parallel and facing each other.

More specifically, in the example shown, auxiliary supporting structure 1 comprises a number of pressure sensors 16 and/or position sensors 17 appropriately located on half-molds 6a, 6b and/or mold platens 4, 5, 11.

More specifically, pressure sensors 16 are appropriately located along the mating surfaces of half-molds 6a, 6b to instantaneously determine the local pressures on the mating surfaces of half-molds 6a, 6b; and position sensors 17 are appropriately located on mold platens 4, 5, 11 and/or half-molds 6a, 6b to instantaneously determine the relative positions of mold platens 4, 5, 11 and/or of half-molds 6a, 6b.

Electronic central control unit 18 controls hydraulic distributor 14 on the basis of an internally memorized computing algorithm, and as a function of the signals from pressure sensors 16 and position sensors 17, so that hydraulic supporting cylinders 12 exert thrust to compensate for any asymmetric distribution of the pulsating mechanical forces arising between half-molds 6a, 6b as the plastic material is injected, and so maintain within predetermined tolerances the extent to which asymmetrically distributed pulsating mechanical forces shift half-mold 6b with respect to its ideal position.

That is, as shown in FIG. 2, when injecting plastic material into molds with widely offset injection holes, electronic central control unit 18 controls hydraulic distributor 14 so that the thrust F₁ exerted by hydraulic cylinders 12 on the plastic material injection side is higher than the thrust F₂ exerted by hydraulic cylinders 12 on the opposite side to that in which plastic material is injected into mold cavity 6, so as to counteract the twisting torque produced by the plastic material injected into mold cavity 6, so that the deviations and/or pressures detected by pressure sensors 16 and position sensors 17 comply with the set operating tolerances throughout the injection stage.

Operation of press 2 and auxiliary supporting structure 1 for actively compensating unbalanced loads, will be clear from the foregoing description, with no further explanation required.

The advantages of auxiliary supporting structure 1, for actively compensating unbalanced loads, are obvious: once fixed to mold platen 5 of press 2, auxiliary supporting structure 1 allows on press 2 injection-compression molding of plastics, despite press 2 being equipped with a simplified platen actuating device 7 allowing no combined control of the position, pressure, or orientation (parallelism) of mold platens 4 and 5.

Auxiliary supporting structure 1 can also be fitted easily to existing presses, to cheaply convert a conventional plastics injection-molding press to one capable of implementing the more evolved, more efficient injection-compression molding process.

Clearly, changes may be made to auxiliary supporting structure 1 and press 2 as described and illustrated herein without, however, departing from the scope of the present invention.

For example, auxiliary supporting structure 1 may be integrated permanently in mold platen 5 of press 2; in which case, hydraulic cylinders 12 are secured stably directly to front surface 5a of mold platen 5, with no need for mounting platen 13, which is eliminated.

1) An auxiliary supporting structure (1) for presses (2), characterized by comprising an auxiliary mold platen (11) having a front surface (11a) designed to firmly, but removably, support a half-mold (6a, 6b), and a number of hydraulic supporting cylinders (12) which project from the rear of said auxiliary mold platen (11) in a direction parallel to a reference axis (L) substantially perpendicular to the plane (P) of the auxiliary mold platen (11); said auxiliary supporting structure (1) also comprising mounting means (13) for firmly, but removably, fixing said hydraulic supporting cylinders (12) to the front surface (5a) of the movable mold platen (5) of a plastics molding press (2), and a hydraulic distributor (14) for regulating pressurized-oil flow to and from each hydraulic supporting cylinder (12) independently of the others; said auxiliary supporting structure (1) also comprising an electronic central control unit (18) for controlling said hydraulic distributor (14) as a function of signals from a number of external sensors (16, 17), to enable said hydraulic supporting cylinders (12) to instantaneously compensate any asymmetric distribution of the mechanical forces exerted on said half-mold (6a, 6b) as the plastic material is injected.

2) An auxiliary supporting structure as claimed in claim 1, characterized in that the movable mold platen (5) of said press (2) moves in a direction parallel to a main axis (L) of the machine substantially perpendicular to the plane of the movable mold platen (5); and in that said auxiliary supporting structure (1) is fixed to the front surface (5a) of said movable mold platen (5), so that its reference axis (L) is parallel to said main axis (L) of the machine.

3) An auxiliary supporting structure as claimed in claim 1, characterized in that said number of sensors (16, 17) comprises a number of pressure sensors (16) appropriately arranged along the mating surface of said half-mold (6a, 6b).

4) An auxiliary supporting structure as claimed in claim 1, characterized in that said press (2) also comprises a fixed mold platen (4) parallel to and facing said movable mold platen (5); and in that said number of sensors (16, 17) comprises at least one number of position sensors (17) appropriately arranged on the fixed mold platen (4) and/or movable mold platen (5) of said press (2), and/or on said auxiliary mold platen (11), and/or on said half-molds (6a, 6b), to instantaneously determine the relative positions of said fixed mold platen (4), said movable mold platen (5), and said auxiliary mold platen (11), and/or of said half-molds (6a, 6b).

5) A plastics molding press (2), characterized by comprising an auxiliary supporting structure (1) as claimed in claim 1.

6) A plastics molding press (2) comprising an on-floor supporting frame (3), a fixed mold platen (4) integral with the supporting frame (3), and a movable mold platen (5) fitted to the supporting frame (3) to move in a direction parallel to a main axis (L) of the machine, while remaining parallel to and facing the fixed mold platen (4); said fixed mold platen (4) and said movable mold platen (5) each having a front surface (4a, 5a) for firmly, but removably, supporting a respective half-mold (6a, 6b); and the press (2) comprising a platen actuating device (7) for moving the movable mold platen (5), on command, towards the fixed mold platen (4) in a direction parallel to said main axis (L), so as to close the half-molds (6a, 6b) fitted to said fixed mold platen (4) and said movable mold platen (5); said press (2) being characterized by also comprising an auxiliary supporting structure (1) interposed between the movable mold platen (5) and the corresponding half-mold (6b), and designed to instantaneously compensate any asymmetric distribution of the mechanical forces exerted on the half-mold (6b) as the plastic material is injected.

7) A press as claimed in claim 6, characterized in that said auxiliary supporting structure (1) comprises an auxiliary mold platen (11) located to the front of said movable mold platen (5), at a predetermined distance from the front surface (5a) of the movable mold platen, and designed to support the corresponding half-mold (6b) firmly but in easily removable manner, a number of hydraulic supporting cylinders (12), which are interposed between the movable mold platen (5) and auxiliary mold platen (11), are parallel to said main axis (L), and each have one axial end resting on the movable mold platen (5), and the other axial end resting on the auxiliary mold platen (11); a hydraulic distributor (14) for regulating pressurized-oil flow to and from each hydraulic supporting cylinder (12) independently of the others; and an electronic central control unit (18) for controlling said hydraulic distributor (14) as a function of signals from a number of external sensors (16, 17), to enable said hydraulic supporting cylinders (12) to instantaneously compensate any asymmetric distribution of the mechanical forces exerted on the half-molds (6a, 6b) as the plastic material is injected.

8) A press as claimed in claim 7, characterized in that said auxiliary supporting structure (1) also comprises mounting means (13) for fixing said hydraulic supporting cylinders (12) rigidly and firmly, but removably, to the front surface (5a) of said movable mold platen (5).

9) A press as claimed in claim 7, characterized in that said number of sensors (16, 17) comprises a number of pressure sensors (16) appropriately arranged along the mating surfaces of said half-molds (6a, 6b).

10) A press as claimed in claim 7, characterized in that said number of sensors (16, 17) comprises a number of position sensors (17) appropriately arranged on said fixed mold platen (4) and said movable mold platen (5), and/or on said auxiliary mold platen (11), and/or on said half-molds (6a, 6b), to instantaneously determine the relative positions of said fixed mold platen (4), said movable mold platen (5), and said auxiliary mold platen (11), and/or of said half-molds (6a, 6b).
